(19) United States
(12) Patent Application Publication
(10) Pub. No.: US 2024/0416798 A1
(43) Pub. Date: Dec. 19, 2024

(54) METHOD AND APPARATUS FOR CONTROLLING HEATING OF VEHICLE BATTERY

(71) Applicants: HYUNDAI MOTOR COMPANY, Seoul (KR); Kia Corporation, Seoul (KR)

(72) Inventors: Jian Xiong ZHAO, Shandong (CN); Fei ZHOU, Shandong (CN); Won Young JEONG, Hwaseong-si (KR); Cai WU, Shandong (CN)

(73) Assignees: HYUNDAI MOTOR COMPANY, Seoul (KR); Kia Corporation, Seoul (KR)

(21) Appl. No.: 18/407,831

(22) Filed: Jan. 9, 2024

(30) Foreign Application Priority Data
Jun. 15, 2023 (CN) 202310710868.X

(51) Int. Cl. B60L 58/27; B60L 58/12; H01M 10/615; H01M 10/625; H01M 10/635

(52) U.S. Cl. CPC B60L 58/27; B60L 58/12; H01M 10/615; H01M 10/625; H01M 10/635; H01M 2220/20

(57) ABSTRACT

In a method and an apparatus for controlling heating of a vehicle battery, the method includes: obtaining, by a receiver, an ambient temperature of a vehicle and battery output power; determining, by a controller, whether the ambient temperature is lower than a predetermined ambient temperature threshold; when it is determined that the ambient temperature is lower than the predetermined ambient temperature threshold, determining, by the controller, whether a battery heating setting is on; and when it is determined that the battery heating setting is on, controlling, by the controller, the heating of the vehicle battery so that the battery output power is between a first reference power and a second reference power.

### CROSS-REFERENCE TO RELATED APPLICATION

The present application claims priority to Chinese Patent Application No. 202310710868.X filed in the Chinese National Intellectual Property Administration on Jun. 15, 2023, the entire contents of which is incorporated herein for all purposes by this reference.

### BACKGROUND OF THE PRESENT DISCLOSURE

### Field of the Present Disclosure

The present disclosure relates to the field of vehicle battery technology, and more to a method and an apparatus for controlling heating of a vehicle battery.

### Description of Related Art

A battery is a power source for an electric vehicle, and it is very important to ensure an efficient operation state of the vehicle battery. Among the many influencing factors, battery temperature has the greatest impact on charge and discharge performance of the vehicle battery. In general, a discharge current of the battery decreases as a temperature decreases within a certain temperature range, and battery output power also decreases due to the temperature drop. Therefore, to ensure the efficient operating state of the battery and to prevent the battery from being in a low performance state for a long time, a temperature increasing function needs to be added to the vehicle battery. Good temperature increasing performance helps to extend battery life, improve safety level of the vehicle, reduce energy consumption of the vehicle, and increase travel distance.

Currently, a method of controlling heating of a battery is typically to trigger the heating of the vehicle battery based on the battery temperature and State of Charge (SOC). That is, when the battery SOC is less than a predetermined SOC threshold (for example, 30%), and when the battery temperature is lower than a predetermined temperature threshold (for example, −5° C.), the vehicle controls a battery heating function to be turned ON, and when the battery temperature is higher than another predetermined temperature threshold (for example, 15° C.), the vehicle controls the battery heating function to be turned OFF. The battery heating function is realized by the heating of the Positive Temperature Coefficient (PTC) element of an air conditioner.

However, the main problem of the method of controlling heating of a battery is that when the SOC is high and the temperature is low (for example, when the SOC is 50% and the battery temperature is −20° C.), the battery heating function is not turned on. Because the output power of the battery varies greatly with the temperature, determining whether the battery is heated based on the temperature of the battery may cause the battery output power to fluctuate and degrade driving experience. When the vehicle is traveling slowly, the power required to run the vehicle is very low, and when the battery is heated in the instant case, the energy of the battery is wasted. Conversely, when the vehicle is traveling fast, the output power of the battery may not be able to meet higher power demanded when the vehicle is traveling.

The vehicles also have different driving modes, such as normal mode, economy mode, and sports mode. However, the existing methods of controlling heating of a battery maintain the same heating trigger conditions in different driving modes. As a result, different driving modes generate the same map of maximum discharge power for the battery, making the driving experience ambiguous.

The above description of the background technology is intended only to facilitate a deeper understanding of the technical methods of the present disclosure (in terms of technical means used, technical problems solved, and technical effects achieved), and should not be construed as acknowledging or implying that the above message forms related art known to those skilled in the art.

### BRIEF SUMMARY

Various aspects of the present disclosure are directed to providing a method and an apparatus for controlling heating of a vehicle battery, which are configured for improving driving experience by reducing fluctuations in battery output power.

An exemplary embodiment of the present disclosure provides a method of controlling heating of a vehicle battery, the method including: obtaining, by a receiver, an ambient temperature of a vehicle and battery output power; determining, by a controller, whether the ambient temperature is lower than a predetermined ambient temperature threshold; when it is determined that the ambient temperature is lower than the predetermined ambient temperature threshold, determining whether a battery heating setting is on; and when it is determined that the battery heating setting is on, controlling, by the controller, heating of the vehicle battery so that the battery output power is between a first reference power and a second reference power.

The method may further include: obtaining, by the receiver, a reference temperature, a battery temperature of the vehicle, and a battery State Of Charge (SOC) of the vehicle battery; determining, by the controller, a maximum discharge power of the vehicle battery according to the reference temperature and the battery SOC; obtaining, by the receiver, a driving mode of the vehicle and a predetermined power corresponding to the driving mode; determining, by the controller, whether the maximum discharge power of the vehicle battery is greater than predetermined power corresponding to the driving mode; determining, by the controller, the first reference power and the second reference power when the maximum discharge power of the vehicle battery is greater than the predetermined power corresponding to the driving mode; and controlling, by the controller, heating the vehicle battery so that the battery output power is between the first reference power and the second reference power.

The controlling of the heating the vehicle battery so that the battery output power is between the first reference power and the second reference power may include: determining whether the battery output power is less than the first reference power; when it is determined that the battery output power is less than the first reference power, heating the vehicle battery; during heating the vehicle battery, determining whether the battery temperature is equal to or higher than a predetermined battery temperature threshold; when it is determined that the battery temperature is equal to or higher than the predetermined battery temperature threshold, stopping the heating of the vehicle battery; when it is determined that the battery temperature is lower than the predetermined battery temperature threshold, determining whether the battery output power is equal to or greater than the second reference power; and when it is determined that the battery output power is equal to or greater than the second reference power, stopping the heating of the vehicle battery.

The first reference power and the second reference power may be determined according to following formula.

$$First reference power = ( power of motor + power of air conditioner + power of low - voltage electrical appliance ) \times first factor \\ Second reference power = ( power of motor + power of air conditioner + power of low - voltage electrical appliance ) \times second factor$$

Herein, the power of the motor may be predetermined power corresponding to the driving mode of the vehicle.

The driving mode of the vehicle may include a normal mode, an economical mode, and a sports mode. The first factor may be 1.1, and the second factor may be 1.2.

The method may further include: when the maximum discharge power of the vehicle battery is equal to or less than the predetermined power corresponding to the driving mode, heating the vehicle battery by the controller; and controlling, by the controller, heating of the vehicle battery so that the battery output power is within the second reference power by use of the maximum discharge power of the vehicle battery as the second reference power.

The controlling of the heating of the vehicle battery so that the battery output power is within the second reference power may include: during heating the vehicle battery, determining, by the controller, whether the battery temperature is equal to or greater than a predetermined battery temperature threshold; when it is determined that the battery temperature is equal to or greater than the predetermined battery temperature threshold, stopping the heating of the vehicle battery by the controller; when it is determined that the battery temperature is lower than the predetermined battery temperature threshold, determining whether the battery output power is equal to or greater than the second reference power; and when it is determined that the battery output power is equal to or greater than the second reference power, stopping the heating of the vehicle battery by the controller.

The method may further include, when it is determined that the ambient temperature is equal to or greater than the predetermined ambient temperature threshold, not executing the heating the vehicle battery by the controller. The method may further include, when it is determined that the ambient temperature is lower than a predetermined ambient temperature threshold and it is determined that the battery heating setting is off, not executing the heating the vehicle battery by the controller.

The battery output power may be the maximum value of the battery output power within a reference time section.

The method may further include: after stopping the heating of the vehicle battery, determining whether the battery output power is less than the second reference power; when the battery output power is less than the second reference power, determining a difference in average battery output power of adjacent predetermined time sections; and increasing or decreasing battery warming and heating power based on the difference.

The method may further include: when the difference between average battery output power of one predetermined time section and average battery output power of a next one predetermined time section is greater than zero, increasing, by the controller, the battery warming and heating power by the difference; and when the difference between the average battery output power of one predetermined time section and the average battery output power of the next one predetermined time section is equal to or less than zero, decreasing, by the controller, the battery warming and heating power by the difference.

The method may further include: during heating the vehicle battery, determining, by the controller, whether the battery temperature is equal to or greater than the predetermined battery temperature threshold; and when it is determined that the battery temperature is equal to or greater than the predetermined battery temperature threshold, stopping the heating of the vehicle battery by the controller.

Another exemplary embodiment of the present disclosure provides an apparatus for controlling heating of a vehicle battery, the apparatus including a receiver and a controller, in which the receiver is configured to obtain an ambient temperature of a vehicle and a battery output power, and the controller is configured to: determine whether the ambient temperature is lower than a predetermined ambient temperature threshold; when it is determined that the ambient temperature is lower than the predetermined ambient temperature threshold, determine whether battery heating setting is on; and when it is determined that the battery heating setting is on, control the heating of the vehicle battery so that the battery output power is between a first reference power and a second reference power.

The receiver may be further configured to: obtain a reference temperature, a battery temperature of the vehicle, and a battery State Of Charge (SOC) of the vehicle battery; and obtain a driving mode of the vehicle and a predetermined power corresponding to the driving mode. The controller may be further configured to: determine a maximum discharge power of the vehicle battery according to the reference temperature and the battery SOC; determine whether the maximum discharge power of the vehicle battery is greater than the predetermined power corresponding to the driving mode; and determine the first reference power and the second reference power when the maximum discharge power of the vehicle battery is greater than the predetermined power corresponding to the driving mode, and control heating the vehicle battery so that the battery output power is between the first reference power and the second reference power.

In the controlling of the heating the vehicle battery so that the battery output power is between the first reference power and the second reference power, the controller may be configured to: determine whether the battery output power is less than the first reference power; when it is determined that the battery output power is less than the first reference power, heating the vehicle battery; during heating the vehicle battery, determine whether the battery temperature is equal to or greater than the predetermined battery temperature threshold; when it is determined that the battery temperature is equal to or greater than the predetermined battery temperature threshold, stop the heating of the vehicle battery; when it is determined that the battery temperature is lower than the predetermined battery temperature threshold, determine whether the battery output power is equal to or greater than the second reference power; and when it is determined that the battery output power is equal to or greater than the second reference power, stop the heating of the vehicle battery.

The controller may be configured to determine the first reference power and the second reference power according to the following formula.

$$First reference power = ( power of motor + power of air conditioner + power of low - voltage electrical appliance ) \times first factor \\ Second reference power = ( power of motor + power of air conditioner + power of low - voltage electrical appliance ) \times second factor$$

Herein, the power of the motor may be the predetermined power corresponding to the driving mode of the vehicle.

The current driving mode of the vehicle may include a normal mode, an economical mode, and a sports mode. The first factor may be 1.1, and the second factor may be 1.2.

The controller may be further configured to heat the vehicle battery when the maximum discharge power of the vehicle battery is equal to or less than predetermined power corresponding to the driving mode, and control heating of the vehicle battery so that the battery output power is within the second reference power by use of the maximum discharge power of the vehicle battery as the second reference power.

The controller may be configured to: in the controlling of the heating of the vehicle battery so that the battery output power is within the second reference power, determine whether the battery temperature is equal to or greater than the predetermined battery temperature threshold, and when it is determined that the battery temperature is equal to or greater than the predetermined battery temperature threshold, stop the heating of the vehicle battery, and when it is determined that the battery temperature is lower than the predetermined battery temperature threshold, determine whether the battery output power is equal to or greater than the second reference power, and when it is determined that the battery output power is equal to or greater than the second reference power, stop the heating of the vehicle battery.

The controller may be configured to: when it is determined that the ambient temperature is equal to or greater than the predetermined ambient temperature threshold, not executing heating the vehicle battery; and when it is determined that the ambient temperature is lower than the predetermined ambient temperature threshold and it is determined that the battery heating setting is off, not executing heating the vehicle battery.

The battery output power may be the maximum value of the battery output power within a reference time section.

The controller may be further configured to, after stopping the heating of the vehicle battery, determine whether the battery output power is less than the second reference power; when the battery output power is less than the second reference power, determine a difference in average battery output power of adjacent predetermined time sections; and increase or decrease battery warming and heating power based on the difference.

The controller may be configured to, when the difference between average battery output power of one predetermined time section and average battery output power of a next one predetermined time section is greater than zero, increase the battery warming and heating power by the difference; and when the difference between the average battery output power of one predetermined time section and the average battery output power of the next one predetermined time section is equal to or less than zero, decrease the battery warming and heating power by the difference.

The controller may be further configured to, during heating the vehicle battery, determine whether the battery temperature is equal to or greater than the predetermined battery temperature threshold, and when it is determined that the battery temperature is equal to or greater than the predetermined battery temperature threshold, stop the heating of the vehicle battery.

The present disclosure utilizes the above technical methods and includes the following beneficial effects.

The method and the apparatus for controlling heating of a vehicle battery determine a battery heating condition based on the ambient temperature outside the vehicle, the battery temperature, the battery SOC value, the battery maximum discharge power, and the battery output power so that battery output power is maintained within a range determined by the first reference power (that is, a heating-on threshold) and the second reference power (that is, heating-off threshold). Therefore, it is possible to reduce fluctuation of the battery output power and improve the driving experience.

By setting the first reference power and the second reference power by use of different target output values according to the battery SOC value, drivers may adapt to the impact of the battery SOC state changes on battery performance. When the SOC value of the vehicle is high, the result of the determination of the predetermined power is used as a target heating output value, and when the SOC value of the vehicle is low, the maximum discharge power curve of the battery is used as the target heating output value.

The different predetermined powers used as the heating-on threshold and the heating-off threshold are set for the different driving modes (normal mode, economical mode, or sports mode). In the sports mode, the battery output power may be maintained as close as possible to the battery output power at normal temperature. In the normal mode, the All Electric Range (AER) value may be expanded. In the economical mode, the vehicle may run further in winter. Different battery output power curves may be obtained in different driving modes, distinguishing the driving experience of the driver in different driving modes. In other words, the driver may clearly feel the different torque outputs in winter.

To mitigate the decrease in the battery output power after the battery heating is stopped, when a “Temperature Maintenance” function is activated, fluctuation in the battery output power may be further reduced. Therefore, this prevents the repetitive heating process and prevents torque variations in the vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

Hereinafter, various exemplary embodiments of the present disclosure will be described in more detail below with reference to the accompanying drawings. For clarity, the same component is denoted by the same reference numeral in different drawings. It should be noted that the drawings are illustrative only, and not necessarily drawn to scale. In these drawings,

FIG. 1A, FIG. 1B and FIG. 1C are graphs of a battery output power, a battery temperature, and a battery SOC when a battery is heated by use of an existing battery heating control method under different powers required to drive the vehicle.

FIG. 2 is a flow diagram of a method of controlling heating of a vehicle battery according to an exemplary embodiment of the present disclosure.

FIG. 3 is a graph of first reference powers, second reference powers, and battery output powers, a battery temperature, a battery SOC value, and powers required to drive a vehicle when a method of controlling heating of a vehicle battery according to an exemplary embodiment of the present disclosure is used in a sports mode, a normal mode and an economical mode.

FIG. 4 is a schematic diagram illustrating heating of a battery according to various heating target powers in a method of controlling heating of a vehicle battery according to an exemplary embodiment of the present disclosure.

FIG. 5 is a graph of a battery output power, a battery SOC value, a battery temperature, and a battery heating power when a method of controlling heating of a vehicle battery according to an exemplary embodiment of the present disclosure is used.

FIG. 6 is a flow diagram of a method of controlling heating of a vehicle battery when a battery is re-heated according to an exemplary embodiment of the present disclosure.

FIG. 7 is a block diagram of an apparatus for controlling heating of a vehicle battery according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The following is a detailed description of an exemplary embodiment of the present disclosure, which is conducted on the premise of the technical scheme of the present disclosure, and provides a detailed implementation method and specific operation process, but the scope of protection of the present disclosure is not limited by the following exemplary embodiment of the present disclosure.

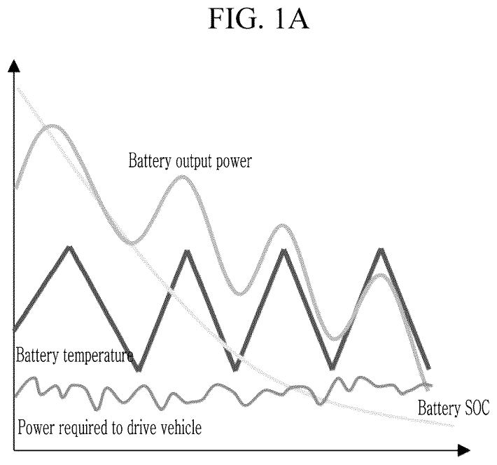

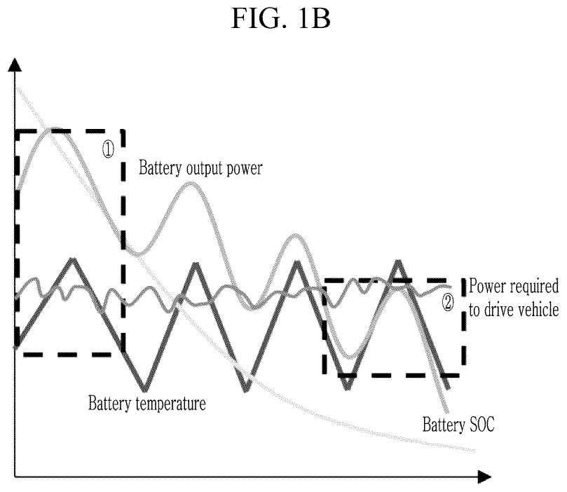

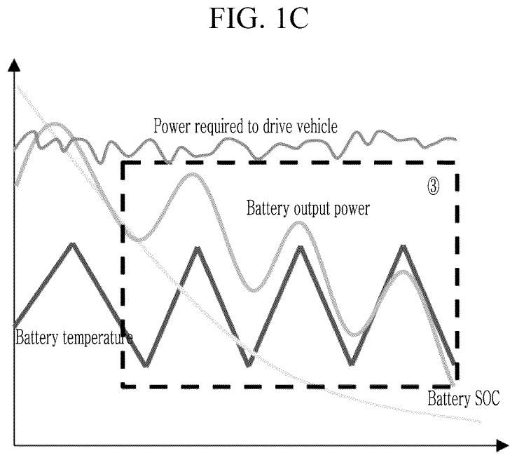

FIG. 1A, FIG. 1B and FIG. 1C are graphs of a battery output power, a battery temperature, and a battery SOC when a battery is heated by use of an existing battery heating control method under different powers required to drive the vehicle. Referring to FIG. 1A, FIG. 1B and FIG. 1C, during a driving of a vehicle, a battery SOC shows a decreasing trend. In an existing battery heating control method, when a battery temperature is lower than a predetermined temperature threshold (for example, −5°° C.), the vehicle is configured to control a battery heating function to be turned on. Therefore, the battery temperature may be maintained stable within a certain range, and the battery output power is determined by the battery SOC value and the battery temperature. When the battery SOC decreases and the battery temperature maintains stable, the battery output power varies. In the instant case, the battery output power generally decreases, deteriorating driving experience.

FIG. 1A shows a curve of a power required to drive the vehicle and a curve of the battery output power when the vehicle is traveling at low speed. As shown in FIG. 1A, the curve of the battery output power is above the curve of the power required to drive the vehicle. When the vehicle is traveling at the low speed, the power required to drive the vehicle is low, but when the battery is in a heated state, the battery output power is much higher than the power required to drive the vehicle, which may cause the battery to be overheated and waste energy. FIG. 1C shows a curve of power required to drive the vehicle and a curve of the battery output power when the vehicle is traveling at high speed. In region \textcircled{3} shown in FIG. 1C, the curve of the battery output power is below the curve of power required to drive the vehicle. When the vehicle is driving rapidly, the power required to drive the vehicle is large, but the battery output power in the heated state of the battery is much lower than the power required to drive the vehicle, such that the heating for the battery is insufficient and the battery output power cannot meet the power required to drive the vehicle. FIG. 1B shows a curve of power required to drive the vehicle and a curve of the battery output power when the vehicle is traveling in an intermediate state between the low-speed traveling and the high-speed traveling. In region \textcircled{1} shown in FIG. 1B, the curve of the battery output power is above the curve of the power required to drive the vehicle. In the instant case, when the battery heats up too rapidly, the battery output power increase too high and energy is wasted. In the region \textcircled{2} shown in FIG. 1B, the curve of the power required to drive the vehicle is above the curve of the battery output power. In the instant case, when the heating temperature is too low, the battery output power is too low, and the battery output power cannot meet the power required to drive the vehicle.

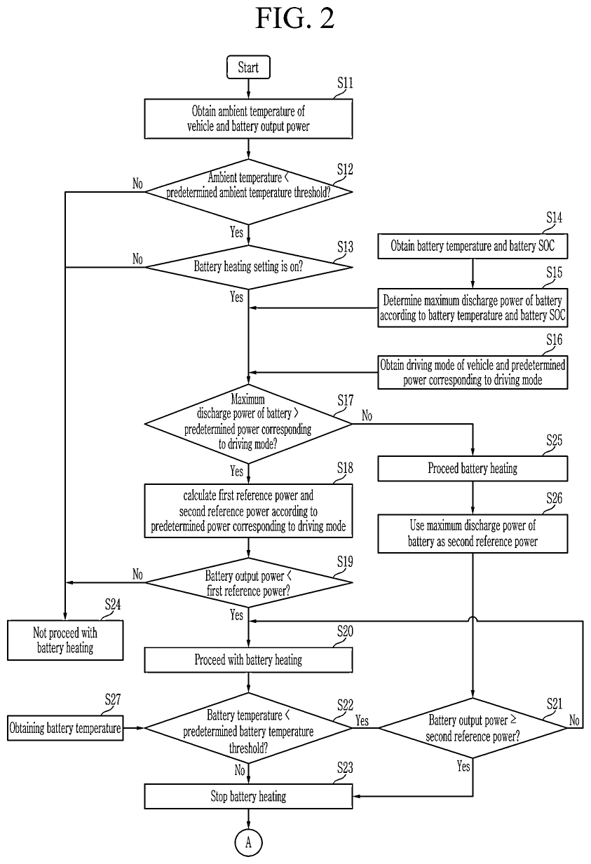

FIG. 2 is a flow diagram of a method of controlling heating of a vehicle battery according to an exemplary embodiment of the present disclosure. As shown in FIG. 2, a method of controlling heating of a vehicle battery according to an exemplary embodiment of the present disclosure may include obtaining an ambient temperature of the vehicle and the battery output power at step S11. In one exemplary embodiment of the present disclosure, the ambient temperature of the vehicle may be obtained from a Dual Automatic Temperature Control (DATC) system and the battery output power may be obtained from a Battery Management System (BMS).

The method of controlling heating of a vehicle battery according to the exemplary embodiment of the present disclosure includes determining whether the ambient temperature is lower than a predetermined ambient temperature threshold at step S12. A person skilled in the art may set the predetermined ambient temperature threshold based on temperature characteristics of winter.

When it is determined that the ambient temperature is equal to or greater than the predetermined ambient temperature threshold (“No” at the step S12), a battery heating is not executed at step S24.

When it is determined that the ambient temperature is lower than the predetermined ambient temperature threshold (“Yes” at the step S12), it is determined whether a battery heating setting is on at step S13. When it is determined that the battery heating setting is off (“No” at the step S13), the battery heating is not executed at the step S24. A battery heating setting option may be provided through an Audio Video Navigation Telematics (AVNT) system of the vehicle. A user may select the battery heating setting option by pressing a button or touching the option shown on the display. For example, when the user does not select the battery heating setting option, the battery heating setting is off. When the user selects the battery heating setting option, the battery heating setting is on.

To solve the problems of the existing method of controlling heating of a vehicle battery, the method of controlling heating of a vehicle battery according to the exemplary embodiment of the present disclosure maintains the battery output power within a specific range, reducing fluctuation of the battery output power and improving driving experience. The specific range may be determined by a first reference power and a second reference power, and the first reference power may be used as a heating-on threshold and the second reference power may be used as a heating-off threshold. Thus, when it is determined the battery heating setting is on (“Yes” at the step S13), the method of controlling heating of a vehicle battery according to the exemplary embodiment of the present disclosure further includes determining whether the battery output power is less than the first reference power at step S19. When the battery output power is less than the first reference power (“Yes” at the step S19), the battery heating is executed at step S20. As the battery heats up, the battery output power increases. When the battery output power is equal to or greater than the second reference power, which is greater than the first reference power (“Yes” at step S21), the battery heating is stopped at step S23.

In the exemplary embodiment of the present disclosure, the battery output power may be a maximum value of the battery output power within a reference time section. Taking the curves of the battery output power of FIG. 1A, FIG. 1B and FIG. 1C as an exemplary embodiment of the present disclosure, the maximum value of the curve of the battery output power in the reference time section may be used as the battery output power. The reference time section may be, but is not limited to, 10 s or 30 s.

The first reference power and the second reference power may be determined based on a target power required for a current load of the vehicle battery. Here, the target power refers to a power value required for a specific operating state during the operation of the vehicle, and may be obtained by a calibration test of the vehicle to achieve optimal dynamic performance and energy saving effect. When the electric vehicle is in the operating state, the load on the battery may be mainly the motor, or other electronic equipment in the vehicle (such as an air conditioner and low-voltage electrical appliances), and the battery output power shall meet the normal operating needs of the above-mentioned load of the vehicle. Therefore, the first reference power and the second reference power are set based on the target power required by the current load of the battery, which not only satisfies the normal power demand for the load, but also reduces energy consumption by setting heating start and heating end times appropriately.

In the exemplary embodiment of the present disclosure, the first reference power and the second reference power may be determined according to the following formula.

$$First reference power = ( power of motor + power of air conditioner + power of low - voltage electrical appliance ) \times first factor \\ Second reference power = ( power of motor + power of air conditioner + power of low - voltage electrical appliance ) \times second factor$$

Here, the power of the motor may be preset to different power values depending on the driving mode of the vehicle. The power of the air conditioner may be the power value of a Positive Temperature Coefficient (PTC) element of the air conditioner. The power of the low-voltage electrical appliances may include the power values of vehicle lamps, blowers, fans, and the like. The second factor is greater than the first factor. The first factor and the second factor may be determined through a number of tests during development phase of the vehicle. In an exemplary embodiment of the present disclosure, the first factor may be 1.1, and the second factor may be 1.2. Furthermore, the calibrated values of the first factor and the second factor may vary depending on the vehicle. The driving mode of the vehicle may include a sports mode, a normal mode, and an economical mode. The method of controlling heating of a vehicle battery according to the exemplary embodiment of the present disclosure may further include obtaining the driving mode of the vehicle and a predetermined power corresponding to the driving mode at step S16. In the exemplary embodiment of the present disclosure, the driving mode of the vehicle may be obtained by obtaining a state of a driving mode selection switch.

The different driving modes have different characteristics. The sports mode focuses on dynamics. The sports mode may prioritize the dynamic performance of the vehicle and neglect the energy consumption due to the battery heating, so that a predetermined power corresponding to the sports mode is high. The normal mode is a mode focusing on a combination of the dynamic performance and economic feasibility. The predetermined power corresponding to the normal mode is neither relatively high nor relatively low, because the normal mode needs to have good dynamic performance and good economic feasibility at the same time. The economical mode may primarily emphasize the economic feasibility and improve energy utilization of the vehicle. The predetermined power corresponding to the economical mode is lower because the economical mode may prioritize reducing the energy used to heat the vehicle battery and extending All Electric Range (AER) of the vehicle. The predetermined powers corresponding to the driving modes of the vehicle may be determined through a number of tests during the development phase of the vehicle. In one exemplary embodiment of the present disclosure, the predetermined power for the sports mode may be set to 120 KW, the predetermined power for the normal mode may be set to 100 KW, and the predetermined power for the economical mode may be set to 60 kW.

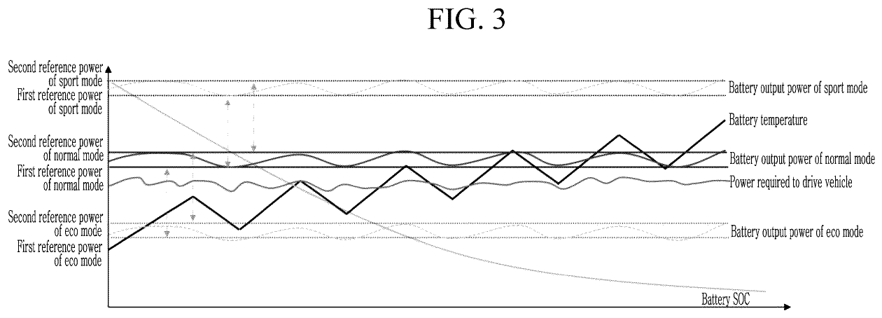

FIG. 3 is a graph of first reference powers, second reference powers, and battery output powers, a battery temperature, a battery SOC value, and powers required to drive a vehicle when a method of controlling heating of a vehicle battery according to an exemplary embodiment of the present disclosure is used in a sports mode, a normal mode, and an economical mode.

As shown in FIG. 3, during the driving of the vehicle, the battery SOC shows the decreasing trend. When the method of controlling heating of a vehicle battery according to the exemplary embodiment of the present disclosure is used, and the vehicle controls the heating function of the battery to be turned on, the battery temperature shows an increasing trend.

Because the predetermined power in the sports mode is greater than the predetermined power in the normal mode, and the predetermined power in the normal mode is greater than the predetermined power in the economical mode, the determination according to the first reference power and second reference power formulas determines that the first reference power in the sports mode is greater than the first reference power in the normal mode, the first reference power in the normal mode is greater than the first reference power in the economical mode, the second reference power in the sports mode is greater than the second reference power in the normal mode, and the second reference power in the normal mode is greater than the second reference power in the economical mode. In FIG. 3, a plurality of straight lines represents, from the top to the bottom, the second reference power in the sports mode, the first reference power in the sports mode, the second reference power in the normal mode, the first reference power in the normal mode, the second reference power in the economical mode, and the first reference power in the economical mode.

When the battery output power is less than the first reference power, the battery heating is executed, and when the battery output power is greater than the second reference power, the battery heating stops. Since the battery output power is the maximum value of the curve of the battery output power in the predetermined time section, the curve of the battery output power in the sports mode is generally located between the straight line representing the first reference power in the sports mode and the straight line representing the second reference power in the sports mode, and the maximum value of the curve of the battery output power in the sports mode does not exceed the straight line representing the second reference power in the sports mode during the battery heating process. Similarly, in the normal mode and the economical mode, the curve of the battery output power is generally located between the straight line representing the first reference power in the corresponding mode and the straight line representing the second reference power in the corresponding mode, and the maximum value of the curve of the battery output power in the normal mode and the economical mode does not exceed the straight line representing the second reference power in the corresponding mode. The method of controlling heating of a vehicle battery according to the exemplary embodiment of the present disclosure may reduce the fluctuation in the battery output power, improving the driving experience.

In the sports mode, the battery output power curve is located above the power curve required to drive the vehicle. The vehicle may have a high battery output power and maintain the battery output power as close as possible to the battery output power at a normal temperature.

In the normal mode, the battery output power curve is located above the power curve required to drive the vehicle, but the distance between the battery output power curve and the power curve required to drive the vehicle is not large. By making the battery output power be greater than the power required to drive the vehicle to meet the driving requirements of the vehicle, and preventing the difference between the battery output power and the power required to drive the vehicle from being too large, wasting energy in the battery is prevented. According to the exemplary embodiment of the present disclosure, on the premise of meeting the basic driving requirements of the user, the battery may be controlled to be heated at an optimal time, preventing the battery heating function from being turned on in advance. It may also be prevented the battery heating function from still not turning on when the dynamic performance of the vehicle does not meet the basic driving requirements of the user (that is, delay of turning on of the battery heating function), not only improving the dynamic performance of the vehicle, but also reducing the additional consumption of the battery energy.

In the economical mode, the battery output power curve is located below the power curve required to drive the vehicle. The vehicle may reduce an amount of the battery energy used to heat the vehicle battery and extend the AER of the vehicle.

According to the exemplary embodiment of the present disclosure, the different battery output power curves may be obtained by setting the different reference powers according to the different driving modes (the normal mode, the economical mode, or the sports mode). Thus, it is possible to distinguish the driving experience of drivers in the different driving modes. In other words, the driver may clearly feel different torque outputs in the different driving modes.

However, when the SOC value of the vehicle is low, using the result of the determination of the predetermined power as a heating target power may cause the battery to overheat and waste energy. Thus, according to the exemplary embodiment of the present disclosure, when the SOC value of the vehicle is low, the maximum discharge power curve of the battery at the reference temperature is used as the heating target power.

The maximum discharge power of the vehicle battery is a power determined by the battery temperature and the battery SOC. In another exemplary embodiment of the present disclosure, the maximum discharge powers of the battery in the different battery SOCs may be obtained based on the test data and maximum and minimum voltage limit values of the vehicle battery. By testing the battery at the different temperatures, a maximum discharge power map may be obtained by establishing a relationship between the maximum discharge power, the temperature, and the SOC. Based on the maximum discharge power map, the onboard BMS may obtain the maximum discharge power of the vehicle battery through interpolation.

The reference temperature means the temperature at which the battery may be discharged at the maximum discharge power in all SOC. The reference temperature may be set between 25° C. and 40° C. Correspondingly, the maximum discharge power curve of the battery at the reference temperature means the maximum discharge power curve of the battery varying according to the SOC at the reference temperature.

The method of controlling heating of a vehicle battery according to the exemplary embodiment of the present disclosure may include obtaining the ambient temperature and the battery output power of the vehicle at the step S11, and obtaining the driving mode of the vehicle and the predetermined power corresponding to the driving mode at the step S16 and obtaining the battery temperature and the battery SOC at step S14 at the same time, before determining whether the maximum discharge power of the vehicle battery is greater than predetermined power corresponding to the driving mode at step S17. In the exemplary embodiment of the present disclosure, the battery temperature and the battery SOC may be obtained from the BMS. Accordingly, the maximum discharge power of the vehicle battery is determined based on the battery temperature and the battery SOC at step S15.

Referring back to FIG. 2, the method of controlling heating of a vehicle battery according to the exemplary embodiment of the present disclosure further includes obtaining the maximum discharge power of the vehicle battery and determining whether the maximum discharge power of the vehicle battery is greater than the predetermined power corresponding to the driving mode at step S17. When the maximum discharge power of the vehicle battery is greater than the predetermined power corresponding to the driving mode (“Yes” at the step S17), the SOC value of the vehicle is in a high state. Therefore, the first reference power and the second reference power are determined according to the predetermined power corresponding to the driving mode at step S18, and the heating of the vehicle battery is controlled so that the battery output power is between the first reference power and the second reference power.

When the maximum discharge power of the vehicle battery is equal to or less than the predetermined power corresponding to the driving mode (“No” at the step S17), the SOC value of the vehicle is in a low state.

The predetermined power corresponding to the driving mode is the preset power associated with the motor. The main load on the battery of the electric vehicle is the motor. When the maximum discharge power of the vehicle battery at the reference temperature (for example, room temperature) cannot meet all of the power required to drive the motor (specifically, the battery SOC is less than 7.3%), it may be determined that the SOC is in a low SOC state. When the SOC value of the electric vehicle is in the low state, the battery output power is low, and in the instant case, the battery output power is consistently less than the power required by the load. In the instant case, the battery heating is directly turned on at step S25 to prevent damage to the battery due to the low temperature.

Furthermore, the maximum discharge power of the vehicle battery is utilized as the second reference power (that is, the heating-off threshold) at step S26, and the heating of the vehicle battery is controlled so that the battery output power is within the second reference power, preventing energy waste of the vehicle battery. It is determined whether the battery output power is equal to or greater than the second reference power at the step S21, and when the battery output power is equal to or greater than the second reference power (“Yes” at the step S21), the heating of the vehicle battery is stopped at the step S23.

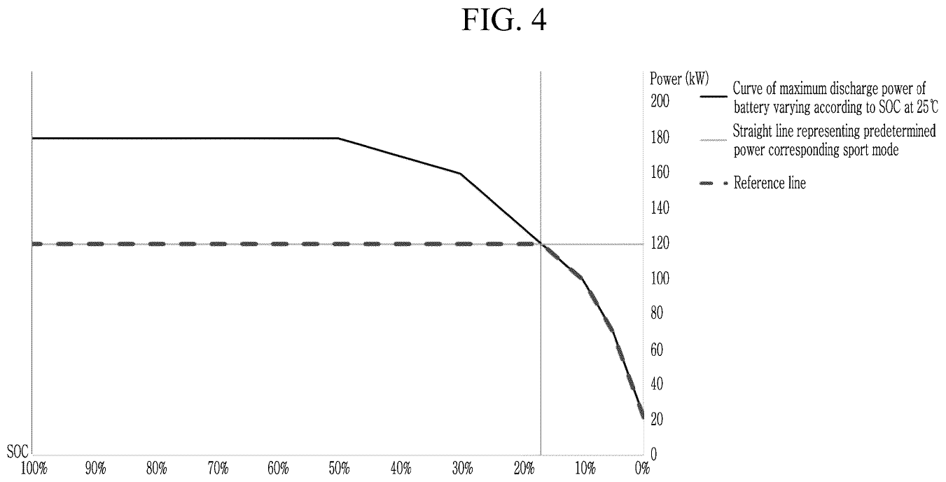

FIG. 4 is a schematic diagram illustrating heating of a battery according to various heating target powers in a method of controlling heating of a vehicle battery according to an exemplary embodiment of the present disclosure. In the present example, the vehicle is in the sports mode and the reference temperature is 25° C. In section \textcircled{1} of FIG. 4, that is, in a process of gradually consuming the SOC from 100% to about 20%, the curve of the maximum discharge power of the vehicle battery varying according to the SOC at a reference temperature of 25° C. is located above the straight line representing the predetermined power (that is, 120 kw) corresponding to the sports mode. When the straight line is used as the reference curve, the method of controlling heating of a battery utilizes the determination result of the predetermined power as the heating target power.

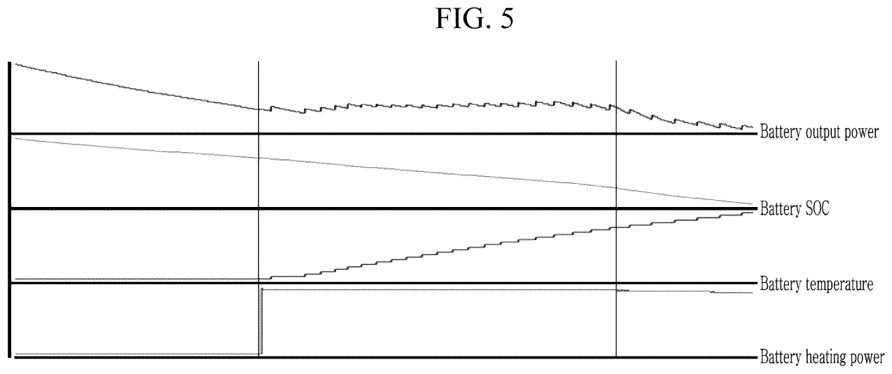

FIG. 5 is a graph of a battery output power, a battery SOC value, a battery temperature, and a battery heating power when a method of controlling heating of a vehicle battery according to an exemplary embodiment of the present disclosure is used. As shown in FIG. 5, in section \textcircled{1} of FIG. 5, the battery heating function is not turned on, and as the battery SOC decreases, the battery output power of the battery also decreases. In section \textcircled{2} of FIG. 5, the battery heating power increases from 0 to a constant value, that is, the battery heating function is turned on and the battery SOC is high. According to the exemplary embodiment of the present disclosure, the battery temperature continues to rise and the battery output power remains stable. For example, in FIG. 3, it may be seen that the battery output power curve remains stable within the section determined by the first reference power and the second reference power. In section \textcircled{3} of FIG. 5, the battery heating function is turned on and the battery SOC is low. According to the exemplary embodiment of the present disclosure, the battery temperature continues to increase, but the battery SOC decreases, and thus the battery output power also decreases.

Referring back to FIG. 2, the method of controlling heating of a vehicle battery according to the exemplary embodiment of the present disclosure provides a battery overheating protecting function. When obtaining the battery temperature at step S27, the battery temperature may be obtained from the BMS, and it is determined whether the battery temperature is lower than a predetermined battery temperature threshold at step S22. A person skilled in the art may set the predetermined battery temperature threshold based on a type, parameters, and the performance of the vehicle battery. When it is determined that the battery temperature is equal to or greater than the predetermined battery temperature threshold (“No” at the step S22), the battery heating is stopped at step S23.

When it is determined that the battery temperature is lower than the predetermined battery temperature threshold (“Yes” at the step S22), it is determined whether the battery output power is equal to or greater than the second reference power at the step S21. When the battery output power is equal to or greater than the second reference power (“Yes” at the step S21), the battery heating is stopped at the step S23.

After stopping the heating of the vehicle battery, the battery output power may begin to decrease again, to be lower than the second reference power. When the battery output power continues to decrease to be equal to or less than the first reference power, the battery needs to be reheated, so that the method may enter a repeated heating process of the vehicle battery. For example, as shown in FIG. 3, the repeated heating may cause the battery output power to vary between the first reference power and the second reference power, causing torque of the vehicle to vary. Thus, according to a further exemplary embodiment of the present disclosure, the power used to warm and heat the vehicle battery in the battery output power controlled in a subsequent battery heating process to mitigate the trend of the battery output power decreasing after reaching the second reference power. Accordingly, it is possible to stably maintain the battery output power and prevent torque fluctuation in the vehicle.

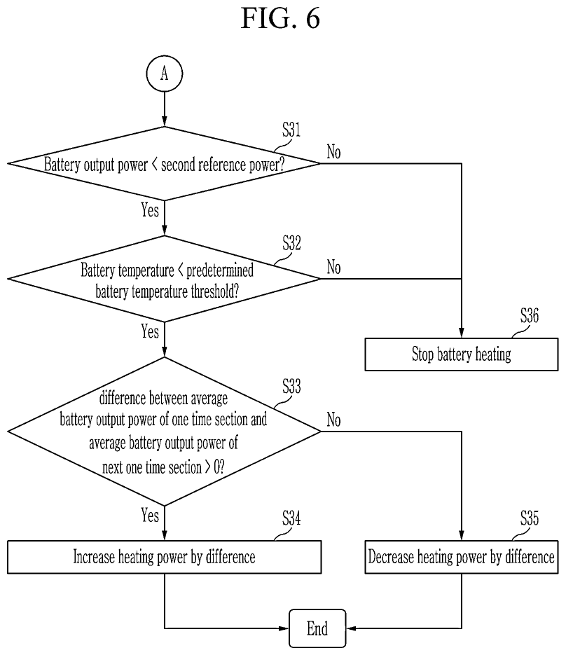

FIG. 6 is a flow diagram of a method of controlling heating of a vehicle battery when the battery is re-heated according to an exemplary embodiment of the present disclosure. As shown in FIG. 6, after stopping the heating of the vehicle battery, it is determined whether the battery output power is less than the second reference power at step S31. When the battery output power is equal to or greater than the second reference power (“No” at the step S31), the stopping of the battery heating is still maintained at step S36. When the battery output power is less than the second reference power (“Yes” at the step S31), it is determined whether the battery temperature is lower than a predetermined battery temperature threshold at step S32. When it is determined that the battery temperature is lower than the predetermined battery temperature threshold (“Yes” at the step S32), the difference among the average battery output power of adjacent predetermined time sections is determined, and battery warming and heating power is increased or decreased based on the difference. The battery temperature threshold at the step S32 may be different from the battery temperature threshold at the step S22.

When the difference between the average battery output power in one predetermined time section and the average battery output power in the next one predetermined time section is greater than zero (“Yes” at step S33), the method of controlling heating of a vehicle battery according to an exemplary embodiment of the present disclosure increases the battery warming and heating power by the corresponding difference at step S34. When the difference between the average battery output power in the one predetermined time section and the average battery output power in the next one predetermined time section is zero or less (“No” at the step S33), the method of controlling heating of a vehicle battery according to an exemplary embodiment of the present disclosure reduces the battery warming and heating power by that difference at step S35. Since the battery output power is the power that meets the normal operating demand of various loads in the vehicle, it is possible to maintain the battery output power stable by controlling the power used for warming and heating of the vehicle battery in the battery output power. Thus, an initial battery heating stabilizes the battery output power between the first reference power and the second reference power, and the subsequent control of the battery warming and heating power may further reduce the fluctuation of the battery output power. Therefore, this prevents the repetitive heating process and prevents the torque fluctuations in the vehicle.

In an exemplary embodiment of the present disclosure, the battery warming and heating power may be power provided for PTC heating, heating film heating, resistance wire heating, liquid heating, or pulse heating in the battery output power.

When it is determined that the battery temperature is equal to or greater than the predetermined battery temperature threshold (“No” at the step S32), the battery heating is stopped to protect the battery from overheating at the step S36.

In an exemplary embodiment of the present disclosure, the method of controlling heating of a vehicle battery may be implemented by a Vehicle Control Unit (VCU).

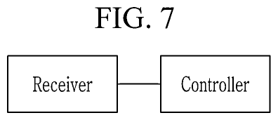

According to another exemplary embodiment of the present disclosure, an apparatus for controlling heating of a vehicle battery is provided. FIG. 7 is a block diagram of an apparatus for controlling heating of a vehicle battery according to an exemplary embodiment of the present disclosure. As shown in FIG. 7, an apparatus for controlling heating of a vehicle battery may include a receiver and a controller. The receiver may be configured to obtain the ambient temperature and the battery output power of the vehicle, and the receiver may be further configured to obtain the reference temperature, the battery temperature, and the battery SOC value of the vehicle, and the driving mode of the vehicle and the predetermined power corresponding to the driving mode. In an exemplary embodiment of the present disclosure, the receiver may obtain the ambient temperature of the vehicle from the DATC system and may obtain the battery output power, the battery temperature, and the battery SOC from the BMS. by obtaining the state of a selection switch of the driving mode, the receiver may obtain the driving mode of the vehicle.

The controller may be configured to determine whether the ambient temperature is lower than a predetermined ambient temperature threshold, when it is determined that the ambient temperature is lower than the predetermined ambient temperature threshold, to determine whether the battery heating setting is turned on, when it is determined that the battery heating setting is turned on, to control the heating of the vehicle battery so that the battery output power is between the first reference power and the second reference power.

Conversely, when it is determined that the ambient temperature is equal to or greater than the predetermined ambient temperature threshold, the controller does not execute the battery heating, and when it is determined that the ambient temperature is lower than the predetermined ambient temperature threshold and it is determined that the battery heating setting is off, the controller does not execute the battery heating.

According to the exemplary embodiment of the present disclosure, the battery output power may be the maximum value of the battery output power within the reference time section.

The controller may be further configured to: determine the maximum discharge power of the vehicle battery based on the reference temperature and the battery SOC; determine whether the maximum discharge power of the vehicle battery is greater than predetermined power corresponding to the driving mode; when the maximum discharge power of the vehicle battery is greater than the predetermined power corresponding to the driving mode, determine the first reference power and the second reference power; and control the heating of the vehicle battery so that the battery output power is between the first reference power and the second reference power.

In the controlling of the heating of the vehicle battery so that the battery output power is between the first reference power and the second reference power, the controller is configured to determine whether the battery output power is less than the first reference power; when it is determined that the battery output power is less than the first reference power, the controller is configured to heat the vehicle battery; in a process of heating the vehicle battery, the controller is configured to determine whether the battery temperature is equal to or greater than the predetermined battery temperature threshold; and when it is determined that the battery temperature is equal to or greater than the predetermined battery temperature threshold, the controller is configured to stop the heating of the vehicle battery. The controller may be configured to, when it is determined that the battery temperature is lower than the predetermined battery temperature threshold, determine whether the battery output power is equal to or greater than the second reference power; and stop the heating of the vehicle battery when it is determined that battery output power is equal to or greater than the second reference power.

The controller may determine the first reference power and the second reference power according to the following formula.

$$First reference power = ( power of motor + power of air conditioner + power of low - voltage electrical appliance ) \times first factor \\ Second reference power = ( power of motor + power of air conditioner + power of low - voltage electrical appliance ) \times second factor$$

Herein, the power of the motor may be predetermined power corresponding to the driving mode of the vehicle. The driving mode of the vehicle may include the sports mode, the normal mode, and the economical mode. The first factor may be 1.1, and the second factor may be 1.2.

The controller may be further configured to heat the vehicle battery when the maximum discharge power of the vehicle battery is equal to or less than predetermined power corresponding to the driving mode, and to control heating of the vehicle battery so that the battery output power of the battery is within the second reference power by use of the maximum discharge power of the vehicle battery as the second reference power.

The controller may be configured to, when controlling heating of the vehicle battery so that the battery output power is within the second reference power, determine whether the battery temperature is equal to or greater than the predetermined battery temperature threshold, and when it is determined that the battery temperature is equal to or greater than the predetermined battery temperature threshold, stop heating of the vehicle battery, and when it is determined that the battery temperature is lower than the predetermined battery temperature threshold, determine whether the battery output power is equal to or greater than the second reference power, and when it is determined that the battery output power is equal to or greater than the second reference power, stop the heating of the vehicle battery.

The controller may be further configured to, after stopping the heating of the vehicle battery, determine whether the battery output power is less than the second reference power; when it is determined that the battery output power is less than the second reference power, determine the difference between the average battery output power of the adjacent predetermined time sections; and increase or decrease the battery warming and heating power based on the difference. When the difference between the average battery output power in one predetermined time section and the average battery output power in the next one predetermined time section is greater than zero, the controller is configured to increase the battery warming and heating power by the difference; and when the difference between the average battery output power in one predetermined time section and the average battery output power in the next one predetermined time section is equal to or less than zero, the controller is configured to decrease the battery warming and heating power by the difference.

Furthermore, the controller may be further configured to, during heating the vehicle battery, determine whether the battery temperature is equal to or greater than the predetermined battery temperature threshold, and when it is determined that the battery temperature is equal to or greater than the predetermined battery temperature threshold, stop the heating of the vehicle battery.

According to the exemplary embodiments of the present disclosure, the method and the apparatus for controlling heating of the vehicle battery are provided to improve the economic feasibility and performance of a New Energy Vehicle (NEV) in low temperature climates. The method and the apparatus for controlling heating of the vehicle battery determine a battery heating condition based on the ambient temperature outside the vehicle, the battery temperature, the battery SOC value, the battery maximum discharge power, and the battery output power so that the battery output power is maintained within the range determined by the first reference power (that is, the heating-on threshold) and the second reference power (that is, the heating-off threshold). Therefore, it is possible to reduce the fluctuation of the battery output power and improve the driving experience.

By setting the first reference power and the second reference power by use of the different target output values according to the battery SOC value, the driver may adapt to the impact of the battery SOC state changes on the battery performance. When the SOC value of the vehicle is high, the result of the determination of the predetermined power is used as the target heating output value, and when the SOC value of the vehicle is low, the maximum discharge power curve of the battery is used as the target heating output value. The different predetermined powers used as the heating-on threshold and the heating-off threshold are set for the different driving modes (normal mode, economical mode, or sports mode).

In fact, the battery heating structure remains unchanged, and the battery heating is controlled with new logic, so that the battery may be heated in a different state. In the sports mode, the battery output power may be maintained as close as possible to the battery output power at normal temperatures. In the normal mode, the AER value at −7° C. may be extended. In the economical mode, the vehicle may run further in winter. The different battery output power curves may be obtained in the different driving modes, distinguishing the driving experience of the driver in the different driving modes. In other words, the driver may clearly feel the different torque outputs in winter.

To mitigate the decrease in the battery output power after the battery heating is stopped, when a “Temperature maintenance” function is activated, the fluctuation in the battery output power may be further reduced. Therefore, this prevents the repetitive heating process and prevents the torque fluctuations in the vehicle.

The various exemplary embodiments of the present disclosure are not intended to be a definitive list of all possible combinations, but rather to illustrate representative aspects of the present disclosure, and what is described in the various exemplary embodiments of the present disclosure may be applied independently or in two or more combinations.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of controlling heating of a vehicle battery, the method comprising:
obtaining, by a receiver, an ambient temperature of a vehicle and battery output power;
determining, by a controller communicatively connected to the receiver, whether the ambient temperature is lower than a predetermined ambient temperature threshold;
upon concluding that the ambient temperature is lower than the predetermined ambient temperature threshold, determining, by the controller, whether a battery heating setting is on; and
upon concluding that the battery heating setting is on, controlling, by the controller, heating of the vehicle battery so that the battery output power is between a first reference power and a second reference power.

2. The method of claim 1, further including:
obtaining, by the receiver, a reference temperature, a battery temperature of the vehicle, and a battery State Of Charge (SOC) of the vehicle battery;
determining, by the controller, a maximum discharge power of the vehicle battery according to the reference temperature and the battery SOC;
obtaining, by the receiver, a driving mode of the vehicle and a predetermined power corresponding to the driving mode;
determining, by the controller, whether the maximum discharge power of the vehicle battery is greater than predetermined power corresponding to the driving mode;
determining, by the controller, the first reference power and the second reference power in response that the maximum discharge power of the vehicle battery is greater than the predetermined power corresponding to the driving mode; and
controlling, by the controller, heating the vehicle battery so that the battery output power is between the first reference power and the second reference power.

3. The method of claim 2, wherein the controlling of the heating the vehicle battery so that the battery output power is between the first reference power and the second reference power includes:
determining whether the battery output power is less than the first reference power;
upon concluding that the battery output power is less than the first reference power, heating the vehicle battery;
during heating the vehicle battery, determining whether the battery temperature is equal to or greater than a predetermined battery temperature threshold;
upon concluding that the battery temperature is equal to or greater than the predetermined battery temperature threshold, stopping the heating of the vehicle battery;
upon concluding that the battery temperature is lower than the predetermined battery temperature threshold, determining whether the battery output power is equal to or greater than the second reference power; and
upon concluding that the battery output power is equal to or greater than the second reference power, stopping the heating of the vehicle battery.

4. The method of claim 3, wherein the first reference power and the second reference power are determined according to following formula:
$$First reference power = ( power of motor + power of air conditioner + power of low - voltage electrical appliance ) \times first factor ; \\ Second reference power = ( power of motor + power of air conditioner + power of low - voltage electrical appliance ) \times second factor ;$$
wherein the power of the motor is the predetermined power corresponding to the driving mode of the vehicle.

5. The method of claim 4,
wherein the driving mode of the vehicle includes a normal mode, an economical mode, and a sports mode, and
wherein the first factor is 1.1, and the second factor is 1.2.

6. The method of claim 2, further including:
in response that the maximum discharge power of the vehicle battery is equal to or less than the predetermined power corresponding to the driving mode, heating the vehicle battery by the controller; and
controlling, by the controller, heating of the vehicle battery so that the battery output power is within the second reference power by use of the maximum discharge power of the vehicle battery as the second reference power.

7. The method of claim 6, wherein the controlling of the heating of the vehicle battery so that the battery output power is within the second reference power includes:
during heating the vehicle battery, determining, by the controller, whether the battery temperature is equal to or greater than a predetermined battery temperature threshold;
upon concluding that the battery temperature is equal to or greater than the predetermined battery temperature threshold, stopping the heating of the vehicle battery by the controller;
upon concluding that the battery temperature is lower than the predetermined battery temperature threshold, determining, by the controller, whether the battery output power is equal to or greater than the second reference power; and
upon concluding that the battery output power is equal to or greater than the second reference power, stopping the heating of the vehicle battery by the controller.

8. The method of claim 1, further including:
upon concluding that the ambient temperature is equal to or greater than the predetermined ambient temperature threshold, not executing the heating the vehicle battery by the controller; and
upon concluding that the ambient temperature is lower than the predetermined ambient temperature threshold and upon concluding that the battery heating setting is off, not executing the heating the vehicle battery by the controller.

9. The method of claim 1, wherein the battery output power is a maximum value of the battery output power within a reference time section.

10. The method of claim 1, further including:
after stopping the heating of the vehicle battery, determining, by the controller, whether the battery output power is less than the second reference power;
in response that the battery output power is less than the second reference power, determining, by the controller, a difference in average battery output powers of adjacent predetermined time sections; and
increasing or decreasing, by the controller, battery warming and heating power based on the difference.

11. The method of claim 10, further including:
in response that a difference between average battery output power of one predetermined time section and average battery output power of a next one predetermined time section is greater than zero, increasing, by the controller, the battery warming and heating power by the difference; and
in response that the difference between the average battery output power of one predetermined time section and the average battery output power of the next one predetermined time section is equal to or less than zero, decreasing, by the controller, the battery warming and heating power by the difference.

12. The method of claim 9, further including:
during heating the vehicle battery, determining, by the controller, whether the battery temperature is equal to or greater than a predetermined battery temperature threshold; and
upon concluding that the battery temperature is equal to or greater than the predetermined battery temperature threshold, stopping the heating of the vehicle battery by the controller.

13. An apparatus for controlling heating of a vehicle battery, the apparatus comprising:
a receiver and a controller communicatively connected to the receiver,
wherein the receiver is configured to obtain an ambient temperature of a vehicle and a battery output power, and
wherein the controller is configured to:
determine whether the ambient temperature is lower than a predetermined ambient temperature threshold;
upon concluding that the ambient temperature is lower than the predetermined ambient temperature threshold, determine whether battery heating setting is on; and
upon concluding that the battery heating setting is on, control heating of the vehicle battery so that the battery output power is between a first reference power and a second reference power.

14. The apparatus of claim 13,
wherein the receiver is further configured to:
obtain a reference temperature, a battery temperature of the vehicle, and a battery State Of Charge (SOC) of the vehicle battery; and
obtain a driving mode of the vehicle and a predetermined power corresponding to the driving mode, and
wherein the controller is further configured to:
determine a maximum discharge power of the vehicle battery according to the reference temperature and the battery SOC;
determine whether the maximum discharge power of the vehicle battery is greater than the predetermined power corresponding to the driving mode; and
determine the first reference power and the second reference power in response that the maximum discharge power of the vehicle battery is greater than the predetermined power corresponding to the driving mode, and control the heating of the vehicle battery so that the battery output power is between the first reference power and the second reference power.

15. The apparatus of claim 14, wherein
in the controlling of the heating the vehicle battery so that the battery output power is between the first reference power and the second reference power, the controller is configured to:
determine whether the battery output power is less than the first reference power;
upon concluding that the battery output power is less than the first reference power, heating the vehicle battery;
during heating the vehicle battery, determine whether the battery temperature is equal to or greater than a predetermined battery temperature threshold;
upon concluding that the battery temperature is equal to or greater than the predetermined battery temperature threshold, stop the heating of the vehicle battery;
upon concluding that the battery temperature is lower than the predetermined battery temperature threshold, determine whether the battery output power is equal to or greater than the second reference power; and
upon concluding that the battery output power is equal to or greater than the second reference power, stop the heating of the vehicle battery.

16. The apparatus of claim 15, wherein
the controller is further configured to determine the first reference power and the second reference power according to following formula,
$$First reference power = ( power of motor + power of air conditioner + power of low - voltage electrical appliance ) \times first factor ; \\ Second reference power = ( power of motor + power of air conditioner + power of low - voltage electrical appliance ) \times second factor ;$$
wherein the power of the motor is the predetermined power corresponding to the driving mode of the vehicle.

17. The apparatus of claim 16,
wherein the driving mode of the vehicle includes a normal mode, an economical mode, and a sports mode, and
wherein the first factor is 1.1, and the second factor is 1.2.

18. The apparatus of claim 14, wherein the controller is further configured to:
heat the vehicle battery in response that the maximum discharge power of the vehicle battery is equal to or less than predetermined power corresponding to the driving mode, and control heating of the vehicle battery so that the battery output power is within the second reference power by use of the maximum discharge power of the vehicle battery as the second reference power.

19. The apparatus of claim 18, wherein the controller is further configured to:
in the controlling of the heating of the vehicle battery so that the battery output power is within the second reference power, determine whether the battery temperature is equal to or greater than a predetermined battery temperature threshold, and upon concluding that the battery temperature is equal to or greater than the predetermined battery temperature threshold, stop the heating of the vehicle battery, and
upon concluding that the battery temperature is lower than the predetermined battery temperature threshold, determine whether the battery output power is equal to or greater than the second reference power, and upon concluding that the battery output power is equal to or greater than the second reference power, stop the heating of the vehicle battery.

20. The apparatus of claim 13, wherein the controller is further configured to:
upon concluding that the ambient temperature is equal to or greater than the predetermined ambient temperature threshold, not executing heating the vehicle battery; and
upon concluding that the ambient temperature is lower than the predetermined ambient temperature threshold and upon concluding that the battery heating setting is off, not executing the heating the vehicle battery.

21. The apparatus of claim 13, wherein the battery output power is a maximum value of the battery output power within a reference time section.

22. The apparatus of claim 13, wherein the controller is further configured to:
after stopping the heating of the vehicle battery, determine whether the battery output power is less than the second reference power;
in response that the battery output power is less than the second reference power, determine a difference in average battery output powers of adjacent predetermined time sections; and
increase or decrease battery warming and heating power based on the difference.

23. The apparatus of claim 22, wherein
the controller is configured to, in response that a difference between average battery output power of one predetermined time section and average battery output power of a next one predetermined time section is greater than zero, increase the battery warming and heating power by the difference; and
in response that the difference between the average battery output power of one predetermined time section and the average battery output power of the next one predetermined time section is equal to or less than zero, decrease the battery warming and heating power by the difference.

24. The apparatus of claim 23, wherein the controller is further configured to:
during heating the vehicle battery, determine whether the battery temperature is equal to or greater than a predetermined battery temperature threshold; and
upon concluding that the battery temperature is equal to or greater than the predetermined battery temperature threshold, stop the heating of the vehicle battery.
